(19) United States
(12) Patent Application Publication
(10) Pub. No.: US 2009/0021471 A1
(43) Pub. Date: Jan. 22, 2009

(54) Light Emitting Device and Method for Driving the Same

(76) Inventors: Seong Soo Park, Gwangsan-gu (KR); Sung Eun Kim, Gwangsan-gu (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 12/281,401

(22) PCT Filed: Feb. 28, 2007
(86) PCT No.: PCT/KR2007/001013

§ 371 Date: Sep. 2, 2008

(30) Foreign Application Priority Data
Mar. 2, 2006 (KR) 10-2006-0020166

(51) Int. Cl. G09G 3/36

(52) U.S. Cl. 345/102

(57) ABSTRACT

A light emitting device is provided. The light emitting device comprises a light emitting unit, a color sensor, a main control unit and a red, green and blue signal control unit. The light emitting unit has a red, a green and a blue LED. The color sensor senses a red, a green and a blue color signal value of light emitted from light emitting unit. The main control unit compares the red, green and blue color signal values with pre-stored target brightness values. Then, the main control unit outputs PWM duty values that have reflected the compensation brightness. The red, green and blue signal control unit drives the red, green and blue LED depending on the PWM duty values output from the main control unit.

### TECHNICAL FIELD

The embodiment of the present invention relates to a lighting device and a method for driving the same.

### BACKGROUND ART

Recently, a light emitting diode (LED) is widely used as a light source of a light emitting device. Particularly, the LED is used as a backlight light source of a liquid crystal display (LCD) panel.

In that case, the backlight light source of the LCD panel includes a plurality of LEDs. A set of a red (R), a green (G) and a blue (B) LED is referred to as a cluster, a plurality of clusters mounted and arranged on a substrate is referred to as a bar, and a row of interconnected R, G or B LEDs in the bar is referred to as a string.

As the LCD panel increases in size, a plurality of bars are used to accommodate an increased number of LEDs.

The RGB LEDs disposed in the bars, however, are not uniform in chromaticity and brightness, causing deviation.

Accordingly, a method for improving brightness and color gamut of a light source with RGB LEDs has been studied. Applying the same operation current to the R, G and B LEDs causes color deviation because the R, G and B LEDs have different color wavelengths.

A control technique for applying different operation currents and different pulse width modulation (PWM) duties to R, G and B LEDs is used for realizing white light in an LCD backlight light source.

The chromaticity and brightness, however, varies with the bars because R, G and B LEDs contained in different bars have different electric characteristics.

Accordingly, when a plurality of bars, each including R, G and B LEDs, are included in an LCD backlight light source, color deviation is caused among bars.

For example, an LCD monitor including 9 bars may have the problem of brightness or color deviation depending on screen positions thereof because the bars have different electric characteristics.

Furthermore, considerable heat is generated in the LED during the conversion of electrical energy to light, and resistance of the LED decreases with increasing temperature. In addition, when electric power of substantially constant voltage is supplied to the LED, resistance of the LED decreases, which may lead to an increase of electric current, and thus to a more significant increase of heat generation.

Such an increased temperature deteriorates the LEDs, affects the performance of the LCD panel including LEDs as a light source, and thus makes it difficult to realize a desired color on the LCD panel.

### DISCLOSURE OF INVENTION

### Technical Problem

The embodiment of the present invention is related to a light emitting device and a method for driving the same that substantially obviates one or more problems due to limitations and disadvantages of the related art.

An embodiment of the present invention provides a light emitting device capable of generating light of uniform brightness.

An embodiment of the present invention provides a light emitting device adequate for a backlight light source of an LCD panel.

An embodiment of the present invention provides a light emitting device formed with the consideration of characteristics of LEDs and characteristics of bars each including a plurality of LEDs.

### Technical Solution

An embodiment of the present invention provides a light emitting device comprising: a light emitting unit having a red light emitting diode, a green light emitting diode and a blue light emitting diode; a color sensor for sensing a red, a green and a blue color signal value of light emitted from the light emitting unit; a main control unit for comparing the red, green and blue color signal values sensed by the color sensor with pre-stored target brightness values to output pulse width modulation duty values that have reflected compensation brightness values; and a red, green and blue signal control unit for driving the red, green and blue light emitting diodes depending on the pulse width modulation duty values output from the main control unit.

An embodiment of the present invention provides a light emitting device comprising: a light emitting unit including a bar having a red, a green and a blue light emitting diode string; a main control unit for outputting pulse width modulation duty values for the red, green and blue light emitting diode strings according to characteristics of the bar; and a red signal control unit, a green signal control unit and a blue signal control unit for driving the red, green and blue light emitting diode strings depending on the respective pulse width modulation duty values output from the main control unit.

An embodiment of the present invention provides a light emitting device comprising: a light emitting unit having a red light emitting diode, a green light emitting diode and a blue light emitting diode; a temperature sensor for sensing heat generation temperature of the light emitting unit; a main control unit for comparing the temperature sensed by the temperature sensor with a predetermined standard temperature table to calculate pulse width modulation duty values for a red, a green and a blue light emitting diodes; and a red, green and blue signal control unit for driving the red, green and blue light emitting diodes depending on the respective pulse width modulation duty values output from the main control unit.

An embodiment of the present invention provides a method for driving a light emitting device, the method including: emitting light from a light emitting unit having a red, a green and a blue string; sensing a red, a green and a blue color signal value of light emitted from the light emitting unit using a color sensor; comparing the red, green and blue color signal values sensed by the color sensor with pre-stored target brightness values to calculate compensation brightness values, and outputting pulse width modulation duty values for the respective red, green and blue light emitting diode strings that have reflected the compensation brightness values using the main control unit; and driving the red, green and blue light emitting diode strings separately depending on the pulse width modulation duty values output from the main control unit.

### ADVANTAGEOUS EFFECTS

According to an embodiment of the present invention, it is possible to provide a light emitting device capable of generating light of uniform brightness, taking into account characteristics of LEDs and characteristics of bars each including a plurality of LEDs.

According to an embodiment of the present invention, it is possible to provide a light emitting device adequate for a backlight light source of an LCD panel.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a light emitting device according to an embodiment of the present invention;

FIG. 2 is a block diagram illustrating how R, G and B LEDs are controlled and compensated for brightness deviations according to an embodiment of the present invention; and

FIG. 3 is a block diagram illustrating how LEDs in a plurality of bars are controlled and compensated for brightness deviations according to an embodiment of the present invention.

### MODE FOR THE INVENTION

Reference will now be made in detail to the preferred embodiments of the present invention, examples of which are illustrated in the accompanying drawings. Wherever possible, the same reference numbers will be used throughout the drawings to refer to the same or like parts.

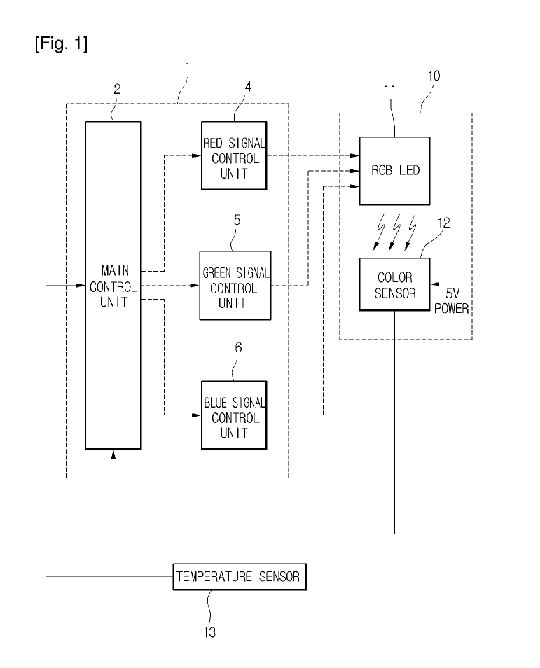

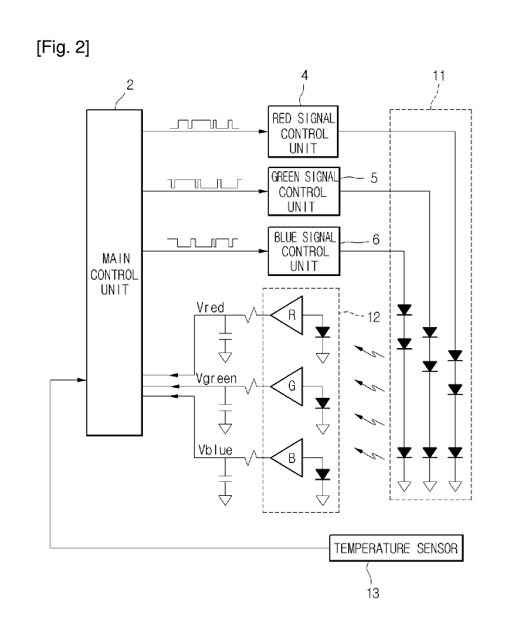

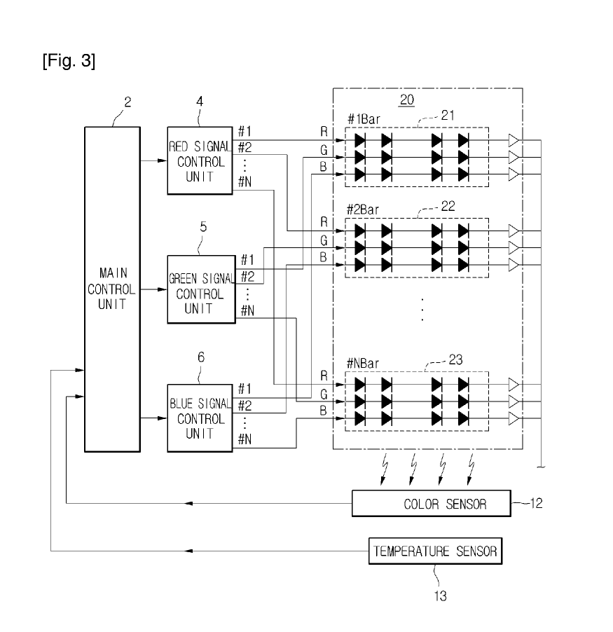

FIG. 1 is a block diagram illustrating a light emitting device according to an embodiment of the present invention. FIG. 2 is a block diagram illustrating how R, G and B LEDs are controlled and compensated for brightness deviations according to an embodiment of the present invention. FIG. 3 is a block diagram illustrating how LEDs in a plurality of bars are controlled and compensated for brightness deviations according to an embodiment of the present invention.

Referring to FIG. 1, an LED driver 1 includes a main control unit 2, a red signal control unit 4 for controlling R LEDs, a green signal control unit 5 for controlling G LEDs, and a blue signal control unit 6 for controlling B LEDs.

The main control unit 2 serves to exchange information with external system and to control the LED driver 1. The R, G and B signal control units 4, 5 and 6 serve to compensate for brightness deviations of the R, G and B LEDs using corresponding modulated PWM duties, respectively.

An LED backlight 10 includes RGB LEDs 11 and a color sensor 12.

A light emitting device of FIG. 2 is generally used as a light source in a small LCD panel such as an LCD panel for a notebook computer.

Referring to FIG. 2, a main control unit 2 is connected to a red signal control unit 4 for controlling a red LED string, a green signal control unit 5 for controlling a green LED string, and a blue signal control unit 6 for controlling a blue LED string.

The R, G and B signal control units 4, 5 and 6 are connected to respective strings of R, G and B LEDs 11.

Color sensors 12 sense light emitted from the R, G and B LEDs 11 to transmit the detected R, G and B signal values to the main control unit 2. The color sensors 12 include photo diodes with color filters to sense R, G and B color signals of incident light separately.

The main control unit 2 calculates brightness values using the R, G, and B signal values and compares them with target brightness values.

The main control unit 2 compares the calculated brightness values and the target brightness values to calculate compensation brightness values for compensating for the differences therebetween. Then, the main control unit 2 computes PWM duty values for the R, G, and B LED strings so that an amount of light corresponding to the compensation brightness values may be emitted.

When the R, G and B signal control units 4, 5 and 6 receive corresponding PWM duty values for the R, G and B LED strings from the main control unit 2, they drive the R, G and B LEDs 11 according to the received PWM duty values.

That is, the main control unit 2 calculates the brightness values from the R, G and B color signal values detected by the color sensor 12, and compares them with the pre-determined target brightness values. Then, the main control unit 2 calculates PWM duty values for the respective R, G and B LED strings to emit white light of the same brightness as the target brightness. Thereafter, the main control unit 2 provides the R, G and B signal control units 4, 5 and 6 with the corresponding compensation values.

FIG. 3 is a block diagram illustrating how LEDs in a plurality of bars are controlled and compensated for brightness deviations according to an embodiment of the present invention.

Referring to FIG. 3, as the LCD panel increases in size, an increased number of LEDs are required for a backlight light source and arranged in a plurality of bars (#1 bar˜#N bar).

FIG. 3 illustrates an embodiment of the present invention for controlling a plurality of LED strings disposed in a plurality of bars and for compensating for brightness deviations.

Each of a red, a green and a blue signal control unit 4, 5 and 6 is connected to N LED strings. That is, the R, G and B signal control units are connected to the corresponding LED strings disposed in #1 bar 21, #2 bar 22, . . . , and #N bar 23, which constitute an LED array 20.

Also, 4 strings of R, G, G and B LEDs may be disposed in each bar. In this case, the two strings of green LEDs may be controlled by a single green signal control unit simultaneously.

A color sensor 12 senses the signal values of the R, G and B colors emitted from the LED array 20 and/or the LCD panel and inputs them into the main control unit 2. A temperature sensor 13 senses the temperatures of the LED array 20 and the LCD panel and inputs them into the main control unit 2.

The main control unit 2 stores PWM duty values for the respective R, G and B LED strings to realize white color in each bar.

That is, the main control unit 2 calculates brightness values from the R, G and B signal values detected by sensing light emitted from each bar. Then, the main control unit 2 compares the calculated brightness values with predetermined target brightness values, and calculates compensation brightness values for compensating for the differences.

Thereafter, the main control unit 2 computes and stores PWM duty values for each of the R, G and B strings to emit white light of the brightness modified with the compensation brightness.

The PWM duty values for the R, G and B LED strings disposed in each bar is determined before the assembling of the plurality of bars to form a backlight light source.

For example, referring to FIG. 3, assuming that the measured signal values of the R, G and B LED strings in #1 bar are 50%, 48% and 53%, respectively, whereas the required values to generate white light are each 50%, the compensation brightness values of the R, G and B LEDs in the #1 bar calculated by the main control unit 2 are +0%, +2% and −3%, respectively.

Also, if the measured signal values of the R, G and B LED strings in #2 bar are 50%, 51% and 49%, respectively, the compensation brightness values of the R, G and B LEDs in the #2 bar calculated by the main control unit 2 are +0%, −1% and +1%, respectively.

Likewise, if the measured signal values of the R, G and B LED strings in #N bar are 47%, 53% and 50%, respectively, the compensation brightness values of the R, G and B LEDs in the #N bar calculated by the main control unit 2 are +3%, −3% and +0%, respectively.

The main control unit 2 calculates standard signal values which compensation brightness values of the R, G and B LED strings in each bar have been applied to, using the above described method.

The R, G and B signal control units 4, 5 and 6 receive the standard signal values for the R, G and B LED strings disposed in each bar from the main control unit 2, and control the R, G and B LED strings disposed in each bar depending on the received standard signal values.

The color sensor 12 senses light emitted from the LED array 20 to detect R, G and B signal values, and transmits the R, G and B signal values to the main control unit 2.

The main control unit 2 calculates brightness values from the R, G, and B signal values and compares them with predetermined target brightness values.

The main control unit 2 compares the calculated brightness values and the target brightness values to calculate compensation brightness values for compensating for the differences. Then, the main control unit 2 computes PWM duty values for respective R, G, and B LEDs so that an amount of light corresponding to the compensation brightness values may be emitted.

For example, the main control unit 2 increases the PWM duty of the R LED string by 1% and that of the G LED string by 3%, and maintains that of the B LED string, regardless of the position of the bar where each of the R, G and B LED strings is disposed.

For example, when the standard signal value of the R LED string in #1 bar is 50% and that in #2 bar is 40%, the main control unit 2 increases the PWM duty of the R LED in #1 bar to 51% and that in #2 bar to 41%.

According to the embodiment described above with reference to FIG. 3, it is possible to realize color of improved accuracy and improved brightness uniformity through the compensation brightness values for compensating brightness deviations of each bar of a plurality of bars in LED array 20 having a plurality of bars and brightness deviations of the LED array 20 as a whole.

Meanwhile, the PWM duties for the LEDs may be compensated for using the temperature of the LED array 20 or the LCD panel which is sensed by the temperature sensor 13. To this end, the main control unit 2 receives the temperature of the LED array 20 or the LCD panel sensed by the temperature sensor 13 and compares it with a pre-stored standard temperature table.

Operation characteristics of the LEDs and LCD panel may vary with temperature change because the LEDs and LCD panel are temperature-sensitive.

For example, operation characteristics of liquid crystal of the LCD panel vary with temperature changes. Accordingly, increasing temperature can make it impossible to realize light of desired color.

Therefore, the variation of the brightness or the color of light depending on temperature is observed before calculating the compensation values of the PWM duties of the R, G and B LEDs depending on temperature.

The main control unit 2 transmits the calculated compensation values of the PWM duties to the R, G and B signal control units 4, 5 and 6 according to the temperature measured by the temperature sensor 13 to compensate for the brightness or color deviations of the RGB LEDs 11 or the LED array 20. If the received temperature is above critical temperature that may exert a fatal influence to the performance of the light emitting device, the main control unit 2 cuts off the electricity in the RGB LEDs 11 or the LED array 20. For example, the critical temperature may be 45° C.

An embodiment of the present invention can be applied to a display device.

It will be apparent to those skilled in the art that various modifications and variations can be made in the present invention. Thus, it is intended that the present invention covers the modifications and variations of this invention provided they come within the scope of the appended claims and their equivalents.

### INDUSTRIAL APPLICABILITY

According to an embodiment of the present invention, it is possible to provide a light emitting device capable of generating light of uniform brightness, taking into account characteristics of LEDs and characteristics of bars each including a plurality of LEDs.

According to an embodiment of the present invention, it is possible to provide a light emitting device adequate for a backlight light source of an LCD panel.

1. A light emitting device comprising:
a light emitting unit including a red light emitting diode, a green light emitting diode and a blue light emitting diode;
a color sensor for sensing a red, a green and a blue color signal value of light emitted from the light emitting unit;
a main control unit for comparing the red, green and blue color signal values sensed by the color sensor with pre-stored target brightness values to output pulse width modulation duty values that have reflected compensation brightness values; and
a red, green and blue signal control unit for driving the red, green and blue light emitting diodes depending on the pulse width modulation duty values output from the main control unit.

2. The light emitting device according to claim 1, wherein the main control unit calculates brightness values from the red, green and blue color signal values sensed by the color sensor, compares the calculated brightness values with the target brightness values to calculate the compensation brightness values, and outputs the pulse width modulation duty values for the respective red, green and blue light emitting diodes that have reflected the compensation values.

3. The light emitting device according to claim 1, wherein the red, green and blue signal control unit comprise a red signal control unit, a green signal control unit and a blue signal control unit to drive the red, green and blue light emitting diodes separately depending on the corresponding pulse width modulation duty values output from the main control unit.

4. The light emitting device according to claim 1, wherein the light emitting unit comprises at least one string of interconnected red light emitting diodes, green light emitting diodes or blue light emitting diodes.

5. The light emitting device according to claim 4, wherein the light emitting unit comprises at least one bar including the string.

6. The light emitting device according to claim 1, wherein the light emitting unit comprises a liquid crystal display backlight light source emitting white light.

7. The light emitting device according to claim 1, comprising a temperature sensor for sensing temperature of the light emitting unit.

8. The light emitting device according to claim 7, wherein the main control unit modulates the pulse width modulation duty values depending on temperature sensed by the temperature sensor and outputs the modulated pulse width modulation duty values.

9. The light emitting device according to claim 7, wherein the main control unit cuts off electricity in the light emitting unit when temperature sensed by the temperature sensor exceeds a critical temperature.

10. A light emitting device comprising:
a light emitting unit including a bar having a red, a green and a blue light emitting diode string;
a main control unit for outputting pulse width modulation duty values for the red, green and blue light emitting diode strings according to characteristics of the bar; and
a red signal control unit, a green signal control unit and a blue signal control unit for driving the respective red, green and blue light emitting diode strings depending on the corresponding pulse width modulation duty values output from the main control unit.

11. The light emitting device according to claim 10, comprising a color sensor for sensing a red, a green and a blue color signal value of light emitted from the light emitting unit,
wherein the main control unit compares the red, green and blue color signal values sensed by the color sensor with pre-stored target brightness values to calculate compensation brightness values, modulates the pulse width modulation duty values for the respective red, green and blue light emitting diode strings that have reflected the compensation brightness values, and outputs the modulated pulse width modulation duty.

12. The light emitting device according to claim 11, wherein the main control unit calculates brightness values from the red, green and blue color signal values sensed by the color sensor to compare the calculated brightness values with the target brightness values.

13. The light emitting device according to claim 10, wherein the light emitting unit comprises a liquid crystal display backlight light source emitting white light.

14. The light emitting device according to claim 10, comprising a temperature sensor for sensing temperature of the light emitting unit.

15. The light emitting device according to claim 14, wherein the main control unit modulates the pulse width modulation duty values depending on temperature sensed by the temperature sensor and outputs the modulated pulse width modulation duty values.

16. The light emitting device according to claim 14, wherein the main control unit turns off power of the light emitting unit when temperature sensed by the temperature sensor exceeds a critical temperature.

17. A light emitting device comprising:
a light emitting unit including a red light emitting diode, a green light emitting diode and a blue light emitting diode;
a temperature sensor for sensing heat generation temperature of the light emitting unit;
a main control unit for comparing the temperature sensed by the temperature sensor with a predetermined standard temperature table to calculate and output pulse width modulation duty values for a red, a green and a blue light emitting diodes; and
a red, green and blue signal control unit for driving the red, green and blue light emitting diodes depending on the respective pulse width modulation duty values output from the main control unit.

18. The light emitting device according to claim 17, comprising a color sensor for sensing a red, a green and a blue color signal value of light emitted from the light emitting unit,
wherein the main control unit compares the red, green and blue color signal values sensed from the color sensor with pre-stored target brightness values to calculate compensation brightness values, and outputs pulse width modulation duty values for a red, a green and a blue light emitting diode that have reflected the compensation brightness values, and
wherein the red, green and blue signal control unit includes a red signal control unit, a green signal control unit and a blue signal control unit.

19. A method for driving a light emitting device, the method comprising:
emitting light from a light emitting unit including a red light emitting diode strings, a green light emitting diode strings and a blue light emitting diode strings;
sensing, at a color sensor, a red, a green and a blue color signal value of light emitted from the light emitting unit;
comparing, at the main control unit, the red, green and blue color signal values sensed at the color sensor with pre-stored target brightness values to calculate compensation brightness values, and outputting pulse width modulation duty values for the respective red, green and blue light emitting diode strings that have reflected the compensation brightness values; and
driving the red, green and blue light emitting diode strings separately depending on the corresponding pulse width modulation duty values output from the main control unit.

20. The method for driving a light emitting device according to claim 19, wherein the main control unit calculates brightness values from the red, green and blue color signal values sensed by the color sensor, and compares the calculated brightness values with the target bright values.
